(19) United States
(12) Patent Application Publication
(10) Pub. No.: US 2018/0052070 A1
(43) Pub. Date: Feb. 22, 2018

(54) ELECTRIC MOTOR

(71) Applicant: FANUC CORPORATION, Yamanashi (JP)

(72) Inventors: Makoto FUNAKUBO, Yamanashi (JP); Yasuo KAWAI, Yamanashi (JP)

(73) Assignee: FANUC CORPORATION, Yamanashi (JP)

(21) Appl. No.: 15/677,186

(22) Filed: Aug. 15, 2017

(30) Foreign Application Priority Data
Aug. 18, 2016 (JP) 2016-160592

(51) Int. Cl. G01M 3/26; H02K 11/20

(52) U.S. Cl. CPC G01M 3/26; H02K 11/20

(57) ABSTRACT

To provide an electric motor capable of reducing the number of work processes for airtight testing, by having a pressure sensor capable of detecting the pressure of an internal space. A motor having an internal space sealed relative to an external space includes: a main body part having a first space constituting the internal space, a stator part that is arranged to be housed in the first space and has a winding, and a rotor part that is entirely or partially arranged to be housed in the first space and has an output shaft; a detection part having a second space that constitutes the internal space and is in communication with the first space; a pressure sensor arranged at the internal space and capable of detecting the pressure of the internal space; and an output part that outputs information of the pressure detected by the pressure sensor out of the motor.

This application is based on and claims the benefit of priority from Japanese Patent Application No. 2016-160592, filed on 18 Aug. 2016, the content of which is incorporated herein by reference.

### BACKGROUND OF THE INVENTION

### Field of the Invention

The present invention relates to an electric motor.

### Related Art

Conventionally, high oil-resistance and waterproof property are demanded in the electric motors (e.g., motor) of machine tools, industrial equipment and industrial robots. In other words, high airtightness is demanded in electric motors.

As an airtight test method for confirming the airtightness of electric motors, a method of confirming the existence of air leaks to the outside or infiltration by confirming a change in the internal pressure after applying positive pressure or vacuum to within the electric motor has been known. As an electric motor improved in order to handle such an airtight test, for example, a motor having an orifice for the airtight test has been proposed (for example, refer to Patent Document 1).

Patent Document 1: Japanese Unexamined Patent Application, Publication No. 2013-51752

### SUMMARY OF THE INVENTION

However, in the invention disclosed in Patent Document 1, components for sealing the orifice for the airtight test, and the work processes for sealing the orifice become necessary. Furthermore, in the airtight test, work processing for directly connecting a device or a type of sensor for detecting leaking of air, or indirectly via a fixture, etc. to the electric motor is also required. In order to conduct the airtight test in this way, many components and working hours have been required.

The present invention has been made taking account of the above situation, and an object thereof is to provide an electric motor capable of decreasing the number of work processes in airtight testing, by having a pressure sensor capable of detecting the pressure of an internal space.

In order to achieve the above-mentioned objects, according to a first aspect of the present invention, an electric motor (e.g., the motor 1 described later) having an internal space sealed relative to an external space (e.g., the internal space 5 described later), includes: a main body part (e.g., the main body part 2 described later) including a first space (e.g., the first space 5a described later) that constitutes the internal space, a stator part (e.g., the stator part 11 described later) that is arranged to be housed in the first space and has a winding, and a rotor part (e.g., the rotor part 13 described later) that is arranged to be housed entirely or partially in the first space and has an output shaft (e.g., the output shaft 13a described later); a detection part (e.g., the detection part 3 described later) having a second space (e.g., the second space 5b described later)) that constitutes the internal space as well as being in communication with the first space; a pressure sensor (e.g., the pressure sensor 6 described later) that is arranged at the internal space and is capable of detecting pressure of the internal space; and an output part (e.g., the output part 7 described later) that outputs information of pressure detected by the pressure sensor out of the electric motor.

According to a second aspect of the present invention, in the electric motor as described in the first aspect, the pressure sensor may be disposed within the first space.

According to a third aspect of the present invention, in the electric motor as described in the second aspect, the pressure sensor may be disposed inside of the stator part.

According to a fourth aspect of the present invention, in the electric motor as described in the first aspect, the pressure sensor may be disposed within the second space.

According to a fifth aspect of the present invention, in the electric motor as described in any one of the first to fourth aspects, an internal pressure that is the pressure of the internal space may be higher than an external pressure that is the pressure of the external space.

In addition, according to a sixth aspect of the present invention, an airtight testing method for the electric motor as described in any one of the first to fourth aspects includes the steps of: adjusting an internal pressure that is the pressure of the internal space to a different pressure from atmospheric pressure; and confirming information of pressure detected by the pressure sensor outputted by the output part, after a certain time elapse since the internal pressure was adjusted to a different pressure from atmospheric pressure in the step of adjusting.

According to the present invention, it is possible to provide an electric motor capable of decreasing the number of work processes in airtight testing, by having a pressure sensor capable of detecting the pressure of an internal space.

### BRIEF DESCRIPTION OF THE DRAWINGS

FIG. 1 is an external perspective view of a motor according to a first embodiment;

FIG. 2 is a side view of the motor according to the first embodiment;

FIG. 3 is a schematic view illustrating an assembly process and airtight test process of the motor according to the first embodiment; and

FIG. 4 is a side view of a motor according to a second embodiment.

### DETAILED DESCRIPTION OF THE INVENTION

Hereinafter, embodiments of the present invention will be explained while referencing the drawings. It should be noted that, in the explanation of a second embodiment, the same reference symbols are attached to configurations shared with the first embodiment, and explanations thereof will be omitted.

### First Embodiment

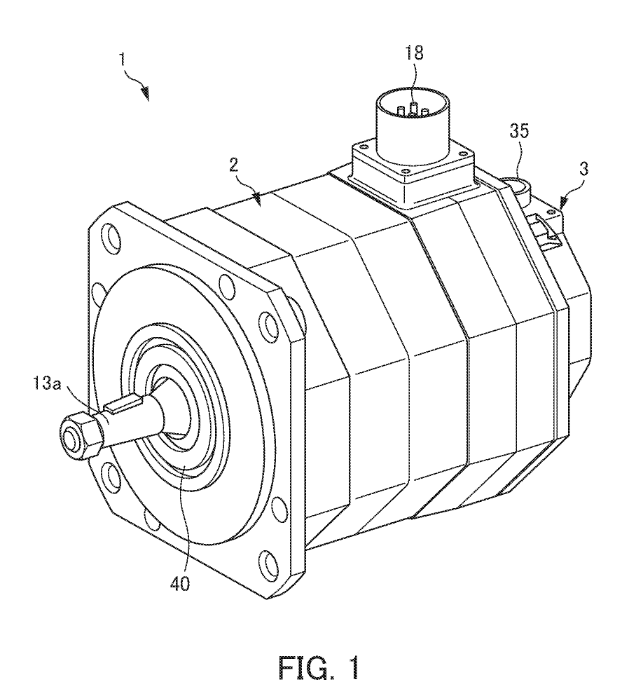

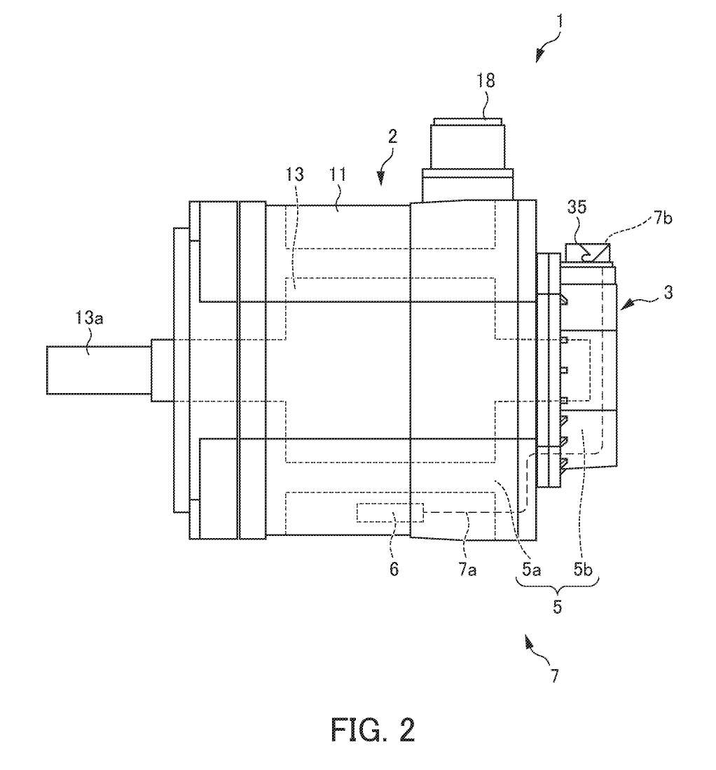

First, the configuration of a motor 1 (electric motor) of a first embodiment will be explained by way of FIGS. 1 and 2. FIG. 1 is an external perspective view of the motor of the first embodiment. FIG. 2 is a side view of the motor of the first embodiment.

As shown in FIGS. 1 and 2, the motor 1 includes a main body part 2, detection part 3, internal space 5 formed throughout the main body part 2 and detection part 3, pressure sensor 6 arranged at the internal space 5, and output part 7 that outputs information of the pressure detected by the pressure sensor 6 out of this electric motor. Herein, the internal space 5 is an internal space sealed relative to an external space. In addition, the internal space 5 is configured to include a first space 5a formed on the side of the main body part 2, and a second space 5b formed on the side of the detection part 3.

The main body part 2 includes the first space 5a constituting the internal space 5, a stator part 11 that is arranged to be housed in the first space 5a and having a winding, and a rotor part 13 that is entirely or partly arranged to be housed in the first space 5a, and having an output shaft 13a. In addition, the main body part 2 has a power supply terminal part 18 at which electric power for driving the motor 1 is inputted. In addition, the main body part 2 is sealed by an oil seal 40, etc.

The detection part 3 is arranged continuously with the main body part 2 in the present embodiment. The detection part 3 has the second space 5b that constitutes the internal space 5, as well as being in communication with the first space 5a. In addition, the detection part 3 has a rotation detection mechanism (not illustrated) which is arranged to be housed in the second space 5b and detects rotation of the rotor part 13, and an information output terminal part 3 arranged to be externally exposed and capable of outputting information detected by the rotation detection mechanism.

The internal space 5 is an internal space sealed relative to an external space, as mentioned above. In addition, the internal space 5 is configured to have the first space 5a formed on the side of the main body part 2, and the second space 5b formed on the side of the detection part 3. Herein, for the airtight testing performed on the motor 1 of the present embodiment after assembly, the pressure of the internal space 5 is adjusted so as to differ from the pressure outside (e.g., atmospheric pressure) during the airtight testing. In the present embodiment, the internal pressure that is the pressure of the internal space 5 is adjusted so as to be higher than the external pressure that is the pressure of the external space. It is thereby possible for the motor 1 to suppress foreign contamination such as liquid from infiltrating into the internal space during assembly, for example.

The pressure sensor 6 is arranged at the internal space 5. In the present embodiment, the pressure sensor 6 is arranged at the first space 5a of the main body part 2. In detail, the pressure sensor 6 is arranged in the rotor part 13.

The pressure sensor 6 is a sensor capable of detecting the pressure (internal pressure) of the internal space 5. The pressure sensor 6 is capable of detecting the pressure of the internal space 5 continuously or at predetermined internals. In addition, the pressure sensor 6 is configured to be able to output the information of the detected pressure to outside of the motor 1 via the output part 7 described later. In the present embodiment, the pressure sensor 6 is configured to be able to output the information of the detected pressure as an electrical signal to outside of the motor 1 via the output part 7.

The output part 7 is configured to be able to output the information of the pressure detected by the pressure sensor 6 out of the motor 1. The output part 7 is configured to be able to output the electrical signal that is the information of the pressure detected by the pressure sensor 6 to outside of the motor 1 in the present embodiment.

The output part 7 is configured to have a signal line 7a and an output terminal 7b. The signal line 7a is arranged from the first space 5a spanning to the second space 5b. The signal line 7a is configured to be able to transmit the electrical signal from the output sensor 6 to the output terminal 7b. The output terminal 7b is arranged to be exposed to outside. In the present embodiment, the output terminal 7b is arranged so as to constitute a part of the information output terminal part 35. The output terminal 7b is connected to an airtight test apparatus described later upon the airtight testing. The output terminal 7b is an output terminal used in airtight testing. The information of pressure outputted from the output terminal 7b is inputted to an airtight test apparatus 50 described later. The airtight test apparatus 50 detects the existence of internal pressure fluctuation based on the information of pressure outputted from the output terminal 7b (electrical signal).

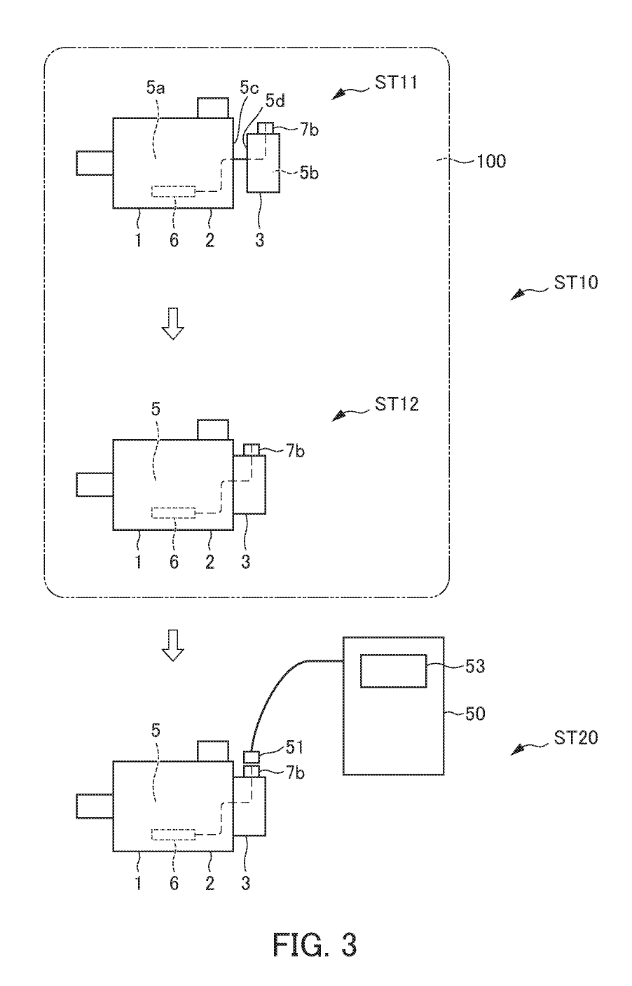

Next, an assembly process and airtight testing process for the motor will be explained according to FIG. 3. FIG. 3 is a schematic view illustrating an assembly process and airtight testing process for the motor according to the first embodiment.

First, in Step ST10, the motor 1 is assembled in an assembly space 100 that is higher pressure than atmospheric pressure. More specifically, in Step ST11, the main body part 2 and detection part 3 of the motor 1 are connected in the assembly space 100 that is higher pressure than atmospheric pressure. Herein, during assembly, the pressure of the first space 5a of the main body part 2 becomes the same pressure as the pressure of the assembly space 100 through a first opening 5c. In addition, similarly, the pressure of the second space 5b of the detection part 3 becomes the same pressure as the pressure of the assembly space 100 through a second opening 5d.

Then, in Step ST12, the motor 1 is completed by assembling in the assembly space 100, which is higher pressure than atmospheric pressure. As mentioned above, the motor 1 is assembled in a state in which the first space 5a and second space 5b are higher pressure than atmospheric pressure in Step ST11; therefore, the internal pressure of the internal space 5 is adjusted so as to be higher pressure than atmospheric pressure. In the present embodiment, Step S12 is a part of a production process, and is a pressure adjusting process of adjusting the internal pressure that is the pressure of the internal space 5 to a different pressure from atmospheric pressure.

Next, in Step ST20, the airtight test is performed on the motor 1. More specifically, first, after a certain time elapse from assembly completion of the motor 1, a pressure information input terminal 51 of the airtight test apparatus 50 is connected to the output terminal 7b (output part 7). The airtight test apparatus 50 displays the pressure during measurement on a display part 53, based on information acquired via the pressure information input terminal 51. Step ST20 is a pressure confirmation process of confirming the information of the pressure detected by the pressure sensor 6 outputted by the output part 7, after a fixed time elapse since the internal pressure was adjusted to different pressure from atmospheric pressure in the aforementioned Step ST12 (pressure adjusting process).

In addition, the airtight test apparatus 50 may be configured so as to determine the result of the airtight testing by way of an airtight testing determination part (not illustrated). For example, the airtight test apparatus 50 may be configured so as to determine as passing in the case of the pressure during measurement being at least a predetermined value, and determine as failing in the case of being less than the predetermined value.

According to the present embodiment, the following effects are exerted. According to the present embodiment, by having the pressure sensor 6 capable of detecting the pressure of the internal space, it is possible to provide the motor 1 (electric motor) capable of decreasing the number of work processes in airtight testing.

More specifically, the motor 1 (electric motor) of the present embodiment is configured so as to have the internal space 5 that is sealed relative to an external space. Then, the motor 1 is configured so as to include the main body part 2 having the first space 5a constituting the internal space 5, a stator part 11 that is arranged to be housed in the first space 5a and having a winding, and a rotor part 13 that is entirely or partly arranged to be housed in the first space 5a, and having an output shaft 13a; the detection part 3 having the second space 5b which constitutes the internal space 5 as well as being in communication with the first space 5a; the pressure sensor 6 arranged at the internal space 5 and capable of detecting the pressure of the internal space 5; and the output part 7 that outputs information of the pressure detected by the pressure sensor 6 out of this motor 1.

The motor 1 is thereby configured to be able to grasp the internal pressure fluctuation by acquiring the pressure information detected by the pressure sensor 6 arranged at the internal space 5. In addition, the motor 1 is thereby configured so as to be able to easily perform airtight testing. Furthermore, the motor 1 can thereby decrease the number of submerged machine parts and tools, etc. Moreover, the motor 1 is configured to able to reduce the work processes and workload in airtight testing.

In addition, the output terminal 7b of the present embodiment is arranged so as to constitute a part of the information output terminal part 35 of the detection part 3. The motor 1 is thereby configured to be able to simultaneously perform airtight testing with normal electrical testing. Furthermore, the motor 1 is thereby configured to be able to further reduce the work processes and workload of airtight testing.

In addition, the pressure sensor 6 of the present embodiment is arranged within the first space 5a on the side of the main body part 2. The motor 1 is thereby configured to have a high degree of freedom in design, as well as reduce the work processes and workload of airtight testing.

In addition, the pressure sensor 6 of the present embodiment is arranged inside of the stator part 11. The motor 1 is thereby configured to be able to reduce the work processes and workload of airtight testing without influencing the arrangement of other members.

Furthermore, for the motor 1 of the present embodiment, the internal pressure that is the pressure of the internal space 5 is adjusted so as to be higher than the external pressure (for example, atmospheric pressure) that is the pressure of an external space. The motor 1 is thereby configured to be able to prevent foreign contamination such as liquid from infiltrating from outside, since being in a state in which the internal pressure of the internal space 5 is higher pressure than the pressure of the external space (for example, atmospheric pressure).

In addition, the airtight testing method for the motor 1 of the present embodiment includes a pressure adjustment process of adjusting the internal pressure which is the pressure of the internal space 5 to be a different pressure from atmospheric pressure; and a pressure confirmation process of confirming the information of pressure detected by the pressure sensor 6 outputted by the output part 7, after a certain time elapse since the internal pressure was adjusted to a different pressure from atmospheric pressure in the pressure adjustment process.

The airtight testing method for the motor 1 thereby becomes able to confirm the airtightness by detecting the pressure fluctuation of the internal space. The airtight testing method for the motor 1 can thereby confirm the airtightness of the motor 1 without requiring submerged machine parts, etc. In addition, the airtight testing of the motor 1 is able to reduce the work processes and workload in airtight testing. Furthermore, due to adjusting so that the internal pressure of the internal space 5 fluctuates in the case of the airtightness being low, the airtight testing method for the motor 1 becomes able to reliably grasp this in the case of the airtightness of the motor 1 being low.

Moreover, in the airtight testing method for the motor 1 of the present embodiment, it is possible to confirm the airtightness of the motor 1 by assembling the motor 1 making the pressure of the internal space 5 differ from the pressure of the external space (for example, atmospheric pressure), and confirming the pressure fluctuation by measuring the pressure of the internal space of a certain time. For this reason, the airtight testing method for the motor 1 can lower the number of steps in the overall manufacturing process of the motor 1 due to being able to conduct part of the steps in the manufacturing process.

### Second Embodiment

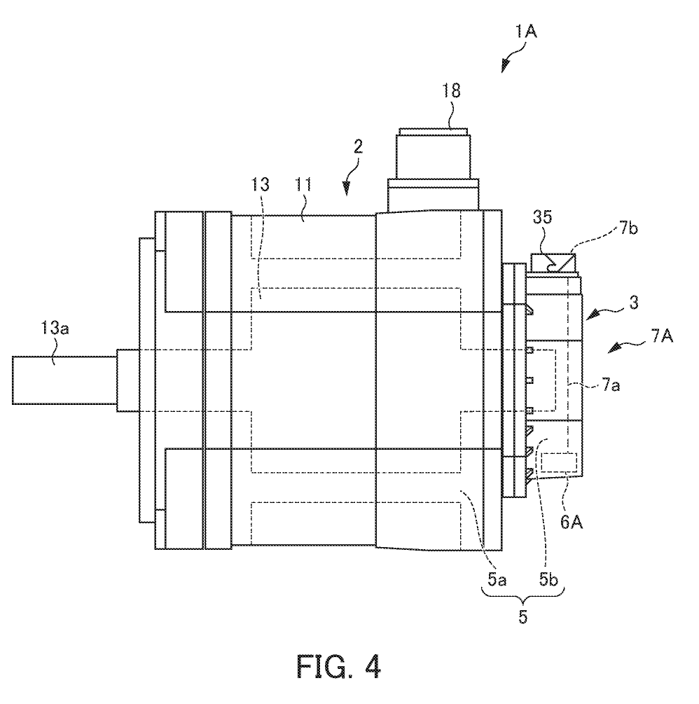

Next, the configuration of a motor according to a second embodiment will be explained by FIG. 4. FIG. 4 is a side view of the motor according to the second embodiment. It should be noted that configurations differing from the first embodiment will be explained hereinafter, and for configurations similar to the first embodiment, explanations thereof will be omitted.

As shown in FIG. 4, a pressure sensor 6A of the present embodiment is arranged within the second space 5b, rather than the first space 5a. In addition, in the present embodiment, a signal line 7a constituting the output part 7A is arranged to be housed only in the second space 5b. In the present embodiment, the pressure sensor 6A and the output part 7A are arranged on the side of the detection part 3. For this reason, the motor 1A of the present embodiment excels in assemblability.

Herein, since the second space 5b is a sealed space in communication with the first space 5a, the pressure sensor 6A can detect the internal pressure of the internal space 5, similarly to the case of being arranged at the first space 5a. The pressure sensor 6A detects the pressure of the internal space 5, as well as outputting information of the detected pressure to outside of the motor 1A via the output part 7A.

According to the present embodiment, the following effects are exerted. The pressure sensor 6A of the present embodiment is arranged within the second space 5b. The pressure sensor 6A and output part 7A (signal line 7a and output terminal 7b) of the present embodiment are thereby arranged only on the side of the detection part 3. The motor 1A is thereby configured to be able to reduce the work schedule and workload of airtight testing, as well as excel in assemblability.

Although the first embodiment and second embodiment are explained above, the present invention is not to be limited thereto. Modifications and improvements within a scope that can achieve the objects of the present invention are also encompassed by the present invention as a matter of course. In the motors of the aforementioned embodiments, the internal pressure of the internal space is adjusted so as to be higher than the pressure of the external space (for example, atmospheric pressure) after assembly; however, it is not limited thereto, and so long as being adjusted to a pressure differing from the pressure of the external space, it may be adjusted so as to be lower than the pressure of the external space.

In addition, in the motors of the aforementioned embodiments, the output terminal outputting pressure information is arranged so as to constitute part of the information output terminal part 35; however, it is not limited thereto, and may be arranged so as to be exposed to outside at any location.

Moreover, in the aforementioned embodiments, it is explained that the airtight testing method for the motor may be configured so as to determine pass/fail in the case of the pressure during measurement exceeding/not exceeding a predetermined value; however, it is not limited thereto, and it may be configured so as to determine by calculating the fluctuation in pressure, for example.

### EXPLANATION OF REFERENCE NUMERALS

1 motor (electric motor)

2 main body part

3 detection part

5 internal space

5a first space

5b second space

6 pressure sensor

7 output part

7a signal line

7b output terminal

11 stator part

13 rotor part

13a output shaft

35 information output terminal part

What is claimed is:

1. An electric motor having an internal space sealed relative to an external space, the electric motor comprising:
a main body part including a first space that constitutes the internal space, a stator part that is arranged to be housed in the first space and has a winding, and a rotor part that is arranged to be housed entirely or partially in the first space and has an output shaft;
a detection part having a second space that constitutes the internal space as well as being in communication with the first space;
a pressure sensor that is arranged at the internal space and is capable of detecting pressure of the internal space; and
an output part that outputs information of pressure detected by the pressure sensor out of the electric motor.

2. The electric motor according to claim 1, wherein the pressure sensor is disposed within the first space.

3. The electric motor according to claim 2, wherein the pressure sensor is disposed inside of the stator part.

4. The electric motor according to claim 1, wherein the pressure sensor is disposed within the second space.

5. The electric motor according to claim 1, wherein an internal pressure that is the pressure of the internal space is higher than an external pressure that is the pressure of the external space.

6. The electric motor according to claim 2, wherein an internal pressure that is the pressure of the internal space is higher than an external pressure that is the pressure of the external space.

7. The electric motor according to claim 3, wherein an internal pressure that is the pressure of the internal space is higher than an external pressure that is the pressure of the external space.

8. The electric motor according to claim 4, wherein an internal pressure that is the pressure of the internal space is higher than an external pressure that is the pressure of the external space.

9. An airtight testing method for the electric motor according to claim 1, the method comprising the steps of:
adjusting an internal pressure that is the pressure of the internal space to a different pressure from atmospheric pressure; and
confirming information of pressure detected by the pressure sensor outputted by the output part, after a certain time elapse since the internal pressure was adjusted to a different pressure from atmospheric pressure in the step of adjusting.

10. An airtight testing method for the electric motor according to claim 2, the method comprising the steps of:
adjusting an internal pressure that is the pressure of the internal space to a different pressure from atmospheric pressure; and
confirming information of pressure detected by the pressure sensor outputted by the output part, after a certain time elapse since the internal pressure was adjusted to a different pressure from atmospheric pressure in the step of adjusting.

11. An airtight testing method for the electric motor according to claim 3, the method comprising the steps of:
adjusting an internal pressure that is the pressure of the internal space to a different pressure from atmospheric pressure; and
confirming information of pressure detected by the pressure sensor outputted by the output part, after a certain time elapse since the internal pressure was adjusted to a different pressure from atmospheric pressure in the step of adjusting.

12. An airtight testing method for the electric motor according to claim 4, the method comprising the steps of:
adjusting an internal pressure that is the pressure of the internal space to a different pressure from atmospheric pressure; and
confirming information of pressure detected by the pressure sensor outputted by the output part, after a certain time elapse since the internal pressure was adjusted to a different pressure from atmospheric pressure in the step of adjusting.
